(19) United States
(12) Patent Application Publication
(10) Pub. No.: US 2011/0150412 A1
(43) Pub. Date: Jun. 23, 2011

(54) RECEIVING DEVICE

(76) Inventors: Jacky Dieumegard, Rennes (FR); Eve Bertucci, Paris (FR); François Toubas, Paris (FR); Marc Juteau, Tremblay en France (FR)

(21) Appl. No.: 12/737,570

(22) PCT Filed: Jun. 17, 2009
(86) PCT No.: PCT/IB2009/052563

§ 371 Date: Feb. 7, 2011

Related U.S. Application Data
(60) Provisional application No. 61/090,278, filed on Aug. 20, 2008.

(51) Int. Cl. H04N 5/76; H04N 5/775

(52) U.S. Cl. 386/230; 386/291; 386/E09.011; 386/E05.07; 386/E05.003

(57) ABSTRACT

A method of operating a receiving device (103) to schedule a recording of an event is described. The method includes: receiving service group data defining a service group, the service group including a plurality of services, each service in the plurality of services being associated with a different video quality, all services in the plurality of services transmitting events according to similar schedules; receiving event data defining an event to be recorded, the event data specifying a service transmitting the event; and if the service transmitting the event is a member of the service group, scheduling a recording of the event using a service in the service group associated with a highest available video quality which the receiving device (103) can access.

### FIELD OF THE INVENTION

The present invention relates to a receiving device for scheduling a recording of an event and to a method of operating such a receiving device.

### BACKGROUND OF THE INVENTION

Video on demand (VOD) systems allow users to select and watch/listen to video or audio content on demand. Push video on demand (push VOD) is a technique used by a number of broadcasters to simulate a video on demand system. A push VOD system uses a Digital Video Recorder (DVR) (sometimes also called a personal video recorder (PVR)) to automatically record a selection of programming, often transmitted in spare capacity overnight. Users can then watch the downloaded programming at times of their choosing. As content occupies space on the DVR hard drive, downloaded content is typically deleted after a predetermined period of time (e.g. one week) to make way for new programs.

A play list of the TV programs to be automatically recorded by the user's DVR is created by a broadcast operator and delivered to the DVRs of all users who have access to the push VOD service (typically every night). Each program is identified according to an identifier and the channel on which it will be broadcast. Some users may have access rights to more channels than other users and therefore the DVR schedules to record each program on the list if the user has access to the channel on which the program will be broadcast or if the channel is free-to-air. The broadcast operator typically also sends the access rights for each TV channel to the DVRs, which provides details of the access rights necessary to access each TV channel.

### SUMMARY OF THE INVENTION

Sometimes, there are TV channels that broadcast the same content at the same time but use a different video format/quality. For example, the same content might be broadcast at the same time on three different TV channels: in standard definition in 4:3 ratio (SD 4:3); in standard definition in 16:9 ratio (SD 16:9); and in high definition (HD). As mentioned previously, some users may have access rights to more channels than other users. For example, some users may subscribe to a high definition service that entitles them to access high definition broadcasting on high definition TV channels. Sometimes, these users also have access to the same programming at an inferior video quality (e.g. on standard definition channels). Moreover, users typically have different video equipment (e.g. 4:3 aspect ration, widescreen (16:9 aspect ratio), etc.) and connectors (e.g. HDMI, component (YUV), SCART, etc.) which may have an effect on the video format and/or quality of the programming that they are able to view. The video format and/or quality of TV programming that a user is able to view may also be affected by settings within a user's DVR (e.g. aspect ratio settings).

To ensure that every push VOD user can view a particular program, the broadcaster typically includes in the play list details of the program on a standard definition 4:3 service. As mentioned previously, the same program may also be available at the same time on a 16:9 standard definition service or a high definition service.

If the broadcaster only includes details of the program on a standard definition 4:3 service, users who are able to view or who have access rights to programming on a 16:9 standard definition service or a high definition service would not be able to view the program in as high a video quality as they would expect. On the other hand, if the broadcaster includes details of the program on a standard definition 4:3 service, on a 16:9 standard definition service and on a high definition service then users will end up with the same TV program recorded three times on their DVR when only one of the recordings is likely to be useful/viewable. Thus the broadcaster typically has to choose between using the lowest video quality (a standard definition 4:3 service) for every user of the push VOD service and filling up the hard disks of users' DVRs with non-useful/non-viewable recordings.

There is provided in accordance with an embodiment of the present invention a method of operating a receiving device to schedule a recording of an event, the method including: receiving service group data defining a service group, the service group including a plurality of services, each service in the plurality of services being associated with a different video quality, all services in the plurality of services transmitting events according to similar schedules; receiving event data defining an event to be recorded, the event data specifying a service transmitting the event; and if the service transmitting the event is a member of the service group, scheduling a recording of the event using a service in the service group associated with a highest available video quality which the receiving device can access.

In some embodiments, the highest available video quality which the receiving device can access is dependent upon use of a suitable connection between the receiving device and a display.

In certain embodiments, the service group data is received in a configuration file including: the service group data and access rights data defining access rights required by the receiving device to access each service in the plurality of services.

In further embodiments, the event data is received from a headend.

In some embodiments, the event data is received in an event playlist defining a plurality of events to be recorded by the receiving device.

In certain embodiments, the event data is received from a user of the receiving device.

There is also provided in accordance with a further embodiment of the present invention a receiving device for scheduling a recording of an event, the receiving device including: means for receiving service group data defining a service group, the service group including a plurality of services, each service in the plurality of services being associated with a different video quality, all services in the plurality of services transmitting events according to similar schedules; means for receiving event data defining an event to be recorded, the event data specifying a service transmitting the event; and means for scheduling a recording of the event using a service in the service group associated with a highest available video quality if the service transmitting the event is a member of the service group.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system constructed and operative in accordance with an embodiment of the present invention; and

FIGS. 2 to 7 are flow charts describing a method of operating a system according to an embodiment of the present invention.

### DETAILED DESCRIPTION OF AN EMBODIMENT

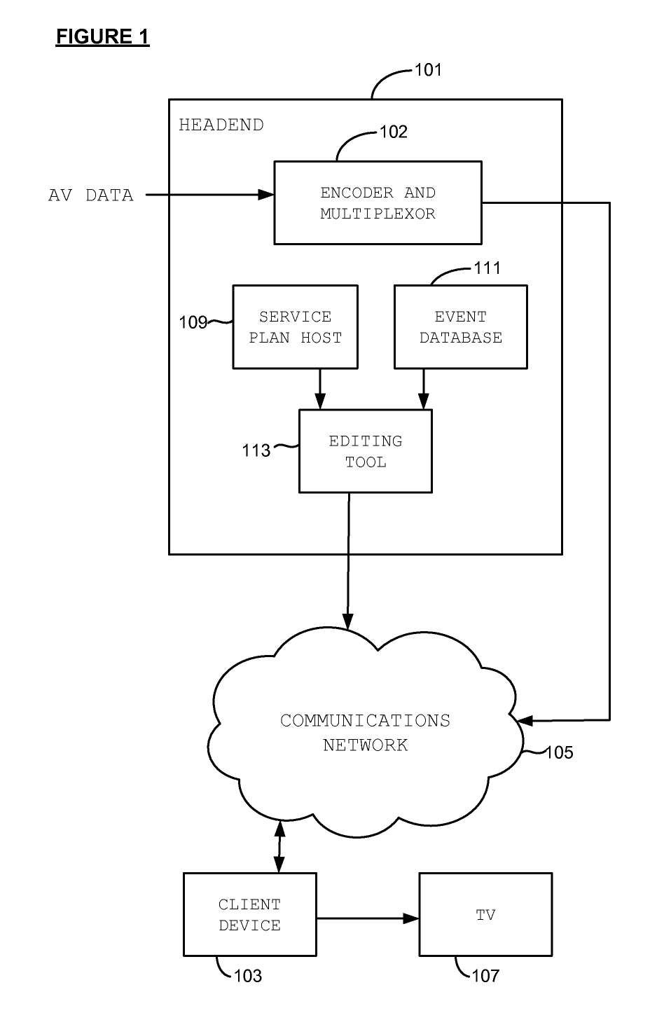

An end-to-end broadcast system constructed and operative in accordance with embodiments of the present invention will now be described in relation to FIG. 1.

Audio video (AV) content is sent to one or more broadcast platform head-ends 101 (for simplicity, only one headend is shown in FIG. 1). In headend 101, the AV content is passed to an encoder and multiplexer 102 where it is compressed (e.g. according to the MPEG-2 standard), packetized and combined with information for decoding and conditional access data to form a multiplexed program transmission.

Headend 101 communicates the multiplexed program transmission to a client receiving device 103 (which will be described in more detail later) via a one-way or two-way communication network 105 that may include at least one of the following: a satellite based communication network; a cable based communication network; a conventional terrestrial broadcast television network; a telephony based communication network; a telephony based television broadcast network; a mobile-telephony based television broadcast network; an Internet Protocol (IP) television broadcast network; and a computer based communication network.

In alternative embodiments, communication network 105 is implemented by a one-way or two-way hybrid communication network, such as a combination cable-telephone network, a combination satellite-telephone network, a combination satellite-computer based communication network, or by any other appropriate network.

Other ways of implementing communication network 105 will be apparent to someone skilled in the art.

Physical links in network 105 are typically implemented via optical links, conventional telephone links, radio frequency (RF) wired or wireless links, or any other suitable links.

Headend 101 communicates with a plurality of client devices via communication network 105. Additionally or alternatively, a plurality of headends 101 communicate with a single client device or with a plurality of client devices via communication network 105. For simplicity of depiction and description, and without limiting the generality of the invention, only one client device and a single headend 101 are illustrated in FIG. 1 and referred to below as communicating via the network 105.

Client device 103 comprises a digital video recorder (DVR) that typically includes a high capacity storage device, such as a hard disk or high capacity memory. Client device is connected to a display device 107. Client device receives, demultiplexes, decodes and decrypts/descrambles as necessary the multiplexed program transmissions under control of a conditional access device such as a removable security element as is well known in the art. The removable security element typically includes a smart card as is well known in the art.

In addition, client device 103 typically includes a processor, such as, for example, an appropriate video processor as is well known in the art. The processor typically includes an operating system that enables processing of the program transmissions.

Client device 103 typically includes at least one audio decoder (not shown) and at least one video decoder (not shown).

Client device 103 is typically implemented in any appropriate combination of hardware and software and at least some of the elements within client device 103 may be comprised in a single integrated circuit (IC).

Client device 103 typically records at least some of the program transmissions received via communication network 105 in the storage device and displays recorded program transmissions at the discretion of a user, at times selected by the user, and in accordance with preferences of the user and parameters defined by the user. Client device 103 typically accepts, via an input interface, user input from an input device such as a remote control that is operated by the user. The user input is typically provided to the processor as instructions.

The following definitions (taken from Digital Video Broadcasting (DVB); Specification for Service Information (SI) in DVB systems, ETSI EN 300 468 V1.8.1) will aid understanding of the embodiments of the present invention to be described below.

Event: grouping of elementary broadcast data streams with a defined start and end time belonging to a common service;

Service: a sequence of programs under the control of a broadcaster which can be broadcast as part of a schedule;

event_id: identification number of an event (uniquely allocated within a service);

Program: concatenation of one or more events under the control of a broadcaster;

MPEG-2: a standard for the generic coding of moving pictures and associated audio information as described in ISO/IEC 13818;

Transport Stream (TS): a communications protocol for audio, video, and data which is specified in MPEG-2 Part 1, Systems (ISO/IEC standard 13818-1;

Network: collection of MPEG-2 Transport Stream (TS) multiplexes transmitted on a single delivery system;

original_network_id: unique identifier of a network;

transport_stream_id: unique identifier of a TS within an original network;

service_id: unique identifier of a service within a TS that distinguishes the service from another service in the TS;

DVB triplet: a way of uniquely identifying a service and distinguishing between the same service carried by different networks. Consists of a combination of the original_network_id, transport_stream_id and service_id;

Conditional Access (CA) system: system to control subscriber access to services, programs and events.

It is to be noted that the terms event and service are sometimes referred to as program and channel in non-DVB contexts.

Headend 101 further comprises: service plan host 109, which stores DVB triplets for the broadcaster's services; event database 111, which stores the event_id of all events available for broadcast by the broadcaster; and editing tool 113 for editing configuration files and play list files to be sent to users.

The structure of configuration files will now be described in more detail. (The structure of play list files will be described in more detail below.)

Typically, the configuration file is an extensible markup language (XML) file. An example XML configuration file scheme is shown below:

```
<?xml version=“1.0” encoding=“UTF-8”?>
<DF NM=“PUSH_VOD_CONFIGURATION”>
  <DB NM=“PUSH_VOD_ACCESS_RIGHTS”>
    <VT NM=“push_vod_service”>
      <IT NM=“push_vod_service_1”>
        <VR NM=“original_network_id” VL=“1”/>
        <VR NM=“transport_stream_id” VL=“1080”/>
        <VR NM=“service_id” VL=“8813”/>
        <VT NM=“OPI_offers”>
          <IT NM=“OPI_offers_1”>
                <VR NM=“opi” VL=“128”/>
                <VR NM=“subscribing_offers” VL=“4”/>
          </IT>
          <IT NM=“OPI_offers_2”>
                <VR NM=“opi” VL=“129”/>
                <VR NM=“subscribing_offers” VL=“42”/>
          </IT>
        </VT>
      </IT>
      <IT NM=“push_vod_service_2”>
        <VR NM=“original_network_id” VL=“1”/>
        <VR NM=“transport_stream_id” VL=“1086”/>
        <VR NM=“service_id” VL=“8402”/>
      </IT>
      <IT NM=“push_vod_service_3”>
        <VR NM=“original_network_id” VL=“1”/>
        <VR NM=“transport_stream_id” VL=“1080”/>
        <VR NM=“service_id” VL=“8814”/>
        <VT NM=“OPI_offers”>
          <IT NM=“OPI_offers_1”>
                <VR NM=“opi” VL=“129”/>
                <VR NM=“subscribing_offers” VL=“42”/>
          </IT>
        </VT>
      </IT>
      <IT NM=“push_vod_service_4”>
        <VR NM=“original_network_id” VL=“1”/>
        <VR NM=“transport_stream_id” VL=“1090”/>
        <VR NM=“service_id” VL=“8000”/>
      </IT>
      <IT NM=“push_vod_service_5”>
        <VR NM=“original_network_id” VL=“1”/>
        <VR NM=“transport_stream_id” VL=“1070”/>
      <VR NM=“service_id” VL=“8005”/>
      <VT NM=“OPI_offers”>
        <IT NM=“OPI_offers_1”>
              <VR NM=“opi” VL=“128”/>
              <VR NM=“subscribing_offers” VL=“6”/>
        </IT>
      </VT>
    </IT>
  </VT>
</DB>
<DB NM=“PUSH_VOD_SERVICE_GROUP”>
  <VT NM=“service_group”>
    <IT NM=“service_group_1”>
      <VT NM=“service_quality”>
        <IT NM=“service_quality_1”>
              <VR NM=“original_network_id” VL=“1” />
              <VR NM=“transport_stream_id” VL=“1086” />
              <VR NM=“service_id” VL=“8402” />
              <VR NM=“quality” VL=“SD_4:3” />
        </IT>
        <IT NM=“service_quality_2”>
              <VR NM=“original_network_id” VL=“1” />
              <VR NM=“transport_stream_id” VL=“1080”/>
              <VR NM=“service_id” VL=“8813” />
              <VR NM=“quality” VL=“SD_16:9” />
        </IT>
        <IT NM=“service_quality_3”>
              <VR NM=“original_network_id” VL=“1” />
              <VR NM=“transport_stream_id” VL=“1080” />
              <VR NM=“service_id” VL=“8814” />
              <VR NM=“quality” VL=“HD” />
        </IT>
        </VT>
      </IT>
    </VT>
  </DB>
</DF>
```

The XML configuration file shown above is split into two blocks: an access rights block and a service groups block.

The access rights block links services to the access rights required by the user to access those services. In the example configuration file above, five services are described:

push_vod_service_1 (identified by DVB triplet (1, 1080, 8813)) is associated with subscription offers from operators 128 and 129. Typically (and as shown above), the subscribing offers correspond to a bitmap of offers. The user has access rights to push_vod_service_1 if at least one of these subscription offers is present on the user's smartcard. For example, if subscribing_offers=4 for operator 128, the user has access rights to push_vod_service_1 if the user has subscription offer 2 for operator 128 (since 4=0x100 and bit number 2 is set to 1 and all the other bit numbers are set to 0). If subscribing_offers=42 for operator 129, the user has access rights to push_vod_service_1 if the user has subscription offer 1, subscription offer 3 or subscription offer 5 for operator 129 (since 42=0x101010 and bit numbers 1, 3 and 5 are set to 1 and all the other bit numbers are set to 0).

push_vod_service_2 and push_vod_service_4 (identified by DVB triplets (1, 1086, 8402) and (1, 1090, 8000) respectively) are both free-to-air channels and therefore no access rights definition is provided in the XML configuration file. All users can therefore access push_vod_service_2 and push_vod_service_4.

push_vod_service_3 (identified by DVB triplet (1, 1080, 8814)) is associated with subscription offers from operator 129. The user has access rights to push_vod_service_3 if at least one of these subscription offers is present on the user's smartcard. If subscribing_offers=42 for operator 129 (as shown above), the user has access rights to push_vod_service_3 if the user has subscription offer 1, subscription offer 3 or subscription offer 5 for operator 129 (since 42=0x101010 and bit numbers 1, 3 and 5 are set to 1 and all the other bit numbers are set to 0).

push_vod_service_5 (identified by DVB triplet (1, 1070, 8005)) is associated with subscription offers from operator 128. The user has access rights to push_vod_service_5 if at least one of these subscription offers is present on the user's smartcard. If subscribing_offers=6 for operator 128 (as shown above), the user has access rights to push_vod_service_5 if the user has subscription offer 1 or subscription offer 2 for operator 128 (since 6=0x110 and bit numbers 1 and 2 are set to 1 and all the other bit numbers are set to 0).

The service groups block contains a description of service groups defined by the broadcaster. A service group is a group of services each broadcasting events according to similar schedules (typically each broadcasting the same events at the same time) where each service in the group is associated to a particular video quality (e.g. standard definition in 4:3 ratio (SD 4:3); standard definition in 16:9 ratio (SD 16:9); and high definition (HD)). In the example configuration file above, one service group (service_group_1) is defined and includes three service qualities: services_quality_1; services_quality_2; and services_quality_3.

push_vod_service_2 (identified by DVB triplet (1, 1086, 8402)) is associated with service_quality_1 (standard definition in 4:3 ratio (SD 4:3)).

push_vod_service_1 (identified by DVB triplet (1, 1080, 8813)) is associated with service_quality_2 (standard definition in 16:9 ratio (SD 16:9)).

push_vod_service_3 (identified by DVB triplet (1, 1080, 8814)) is associated with service_quality_3 (high definition (HD)).

Therefore, push_vod_service_1, push_vod_service_2, and push_vod_service_3 all broadcast the same content at the same time but using different video qualities. In the present example, push_vod_service_4 and push_vod_service_5 are not contained in any service group.

The structure of play list files will now be described in more detail. Typically, the play list file is an extensible markup language (XML) file. An example XML play list file scheme is shown below:

```
<?xml version=“1.0” encoding=“UTF-8”?>
<DF NM=“PUSH_VOD_PLAYLIST”>
  <DB NM=“PUSH_VOD_EVENTS”>
    <VT NM=“push_vod_event”>
      <IT NM=“push_vod_event_A”>
        <VR NM=“Eid” VL=“2000”/>
        <VR NM=“ONid” VL=“1”/>
        <VR NM=“TSid” VL=“1090”/>
        <VR NM=“Sid” VL=“8000”/>
      </IT>
      <IT NM=“push_vod_event_B”>
        <VR NM=“Eid” VL=“2001”/>
        <VR NM=“ONid” VL=“1”/>
        <VR NM=“TSid” VL=“1070”/>
        <VR NM=“Sid” VL=“8005”/>
      </IT>
      <IT NM=“push_vod_event_C”>
        <VR NM=“Eid” VL=“2002”/>
        <VR NM=“ONid” VL=“1”/>
        <VR NM=“TSid” VL=“1086”/>
        <VR NM=“Sid” VL=“8402”/>
      </IT>
    </VT>
  </DB>
</DF>
```

The play list file is created at headend 101. The broadcast operator selects which events (i.e. which TV programs) are to be ‘pushed’ to be available to the users and these events are added to the play list file. The play list file therefore contains a plurality of events. Each event in the play list file is defined according to its event_id and the DVB triplet of the service in which the event is to be broadcast.

push_vod_event_A (identified by event_id 2000) is the first event in the example play list above and is specified as being broadcast on push_vod_service_4 (identified by DVB triplet (1, 1090, 8000)). It will be remembered that push_vod_service_4 is not contained in a service group.

push_vod_event_B (identified by event_id 2001) is the second event in the example play list above and is specified as being broadcast on push_vod_service_5 (identified by DVB triplet (1, 1070, 8005)). It will be remembered that push_vod_service_5 is not contained in a service group.

push_vod_event_C (identified by event_id 2002) is the third event in the example play list above and is specified as being broadcast on push_vod_service_2 (identified by DVB triplet (1, 1086, 8402)). It will be remembered that push_vod_service_2 is contained in service_group_1.

Having created the configuration file and the play list file, the broadcast operator sends these to the DVRs of push VOD service users.

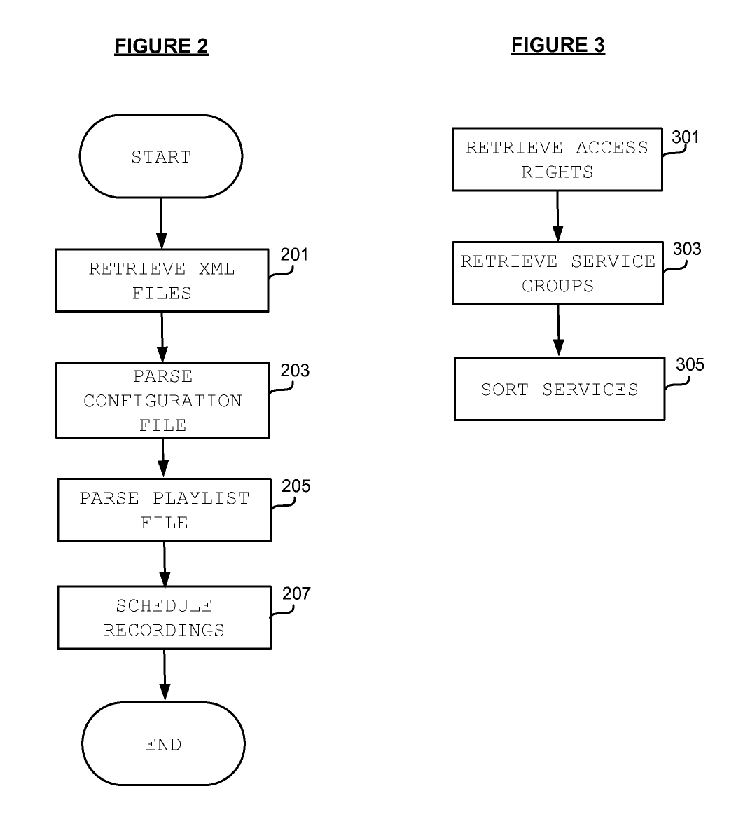

A method of operating a push VOD service according to embodiments of the present invention will now be described in relation to FIGS. 2 to 7.

Client device 103 schedules to record the TV programs ‘pushed’ to client device 103 by the broadcaster. The scheduling of the recordings is typically performed every night during a maintenance phase of client device 103.

Referring first to FIG. 2, client device 103 retrieves the configuration and play list XML files from the broadcast stream (step 201). Then client device 103 parses the configuration XML file (step 203) and parses the play list XML file (step 205). Finally, client device 103 schedules to record TV programs (events) found in the play list XML file (step 207).

The step of parsing the configuration XML file (step 203) will now be described in more detail in relation to FIG. 3.

In parsing the configuration XML file, client device 103 retrieves the access rights by service data (step 301) and then retrieves the service groups data (step 303). Client device 103 then typically sorts the list of services in each retrieved service group from the highest video quality to the lowest video quality available to the user (step 305). The availability of HD and SD 16:9 typically depends on the types of connection used to connect client device 103 to display device 107 and on any user settings specified in client device 103 with respect to client device 103 and/or display device 107.

In the present embodiment, client device 103 retrieves service_group_1 from the configuration XML file and then sorts the three services resulting in the sorted list: push_vod_service_3 (high definition (HD)), push_vod_service_1 (standard definition in 16:9 ratio (SD 16:9)), push_vod_service_2 (standard definition in 4:3 ratio (SD 4:3)).

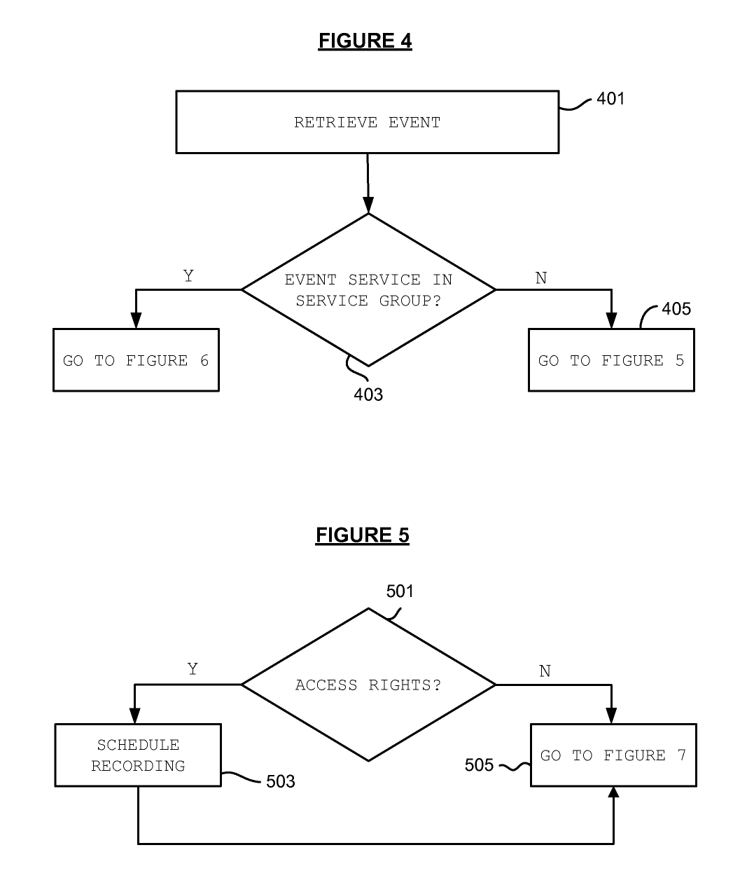

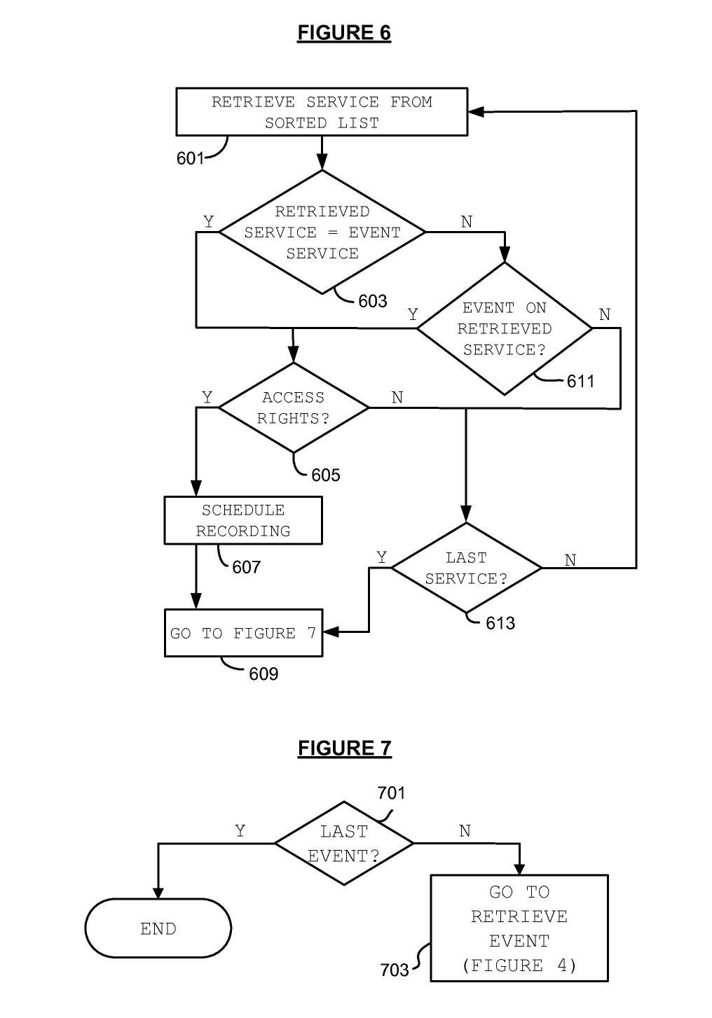

The step of parsing the play list XML file (step 205) will now be described in more detail in relation to FIG. 4.

Client device 103 parses the first event listed in the play list XML file (step 401) and then determines if the service specified with the event belongs to a service group (step 403) using the data retrieved in step 303. If it is determined that the service specified with the event does not belong to a service group, a process is followed that will be described in more detail below in relation to FIG. 5. If it is determined that the service specified with the event does belong to a service group, a process is followed that will be described in more detail below in relation to FIG. 6.

The process followed if it is determined in step 403 that the service specified with the event does not belong to a service group will now be described in more detail in relation to FIG. 5.

Client device 103 checks to see if the user has rights to access the service specified with the event (step 501). This includes checking the access rights as specified in the data retrieved in step 301.

If the user does have rights to access the service specified with the event, client device 103 schedules the recording of the event (step 503) and then follows a process that will be described in more detail below in relation to FIG. 7 (step 505). If the user does not have rights to access the service specified with the event, client 103 just follows the FIG. 7 process (step 505).

The process followed if it is determined in step 403 that the service specified with the event does belong to a service group will now be described in more detail in relation to FIG. 6.

Client device 103 retrieves the first service from the sorted list produced in step 305 (step 601) and then checks whether or not the service retrieved from the sorted list (hereinafter referred to as the retrieved service) is the same as the service specified with the event currently being processed (hereinafter referred to as the event service) (step 603).

If the event service is the same as the retrieved service (i.e. the event service corresponds to service in the service group having the highest video quality) client device 103 checks to see if the user has rights to access the retrieved service (step 605).

If the user does have rights to access the retrieved service, client device 103 schedules the recording of the event (step 607) and then follows the FIG. 7 process (step 609).

If the event service is not the same as the retrieved service (i.e. the event service does not correspond to the highest video quality service) client device 103 searches schedule data to check whether or not the event currently being processed is available on the retrieved service (step 611).

If the event currently being processed is available on the retrieved service, client device 103 checks to see if the user has rights to access the retrieved service (step 605), as described above.

If the event currently being processed is not available on the retrieved service, client device 103 then checks whether or not the service currently being processed is the last service in the sorted list of services from step 305 (step 613).

If the service currently being processed is not the last service in the sorted list of services from step 305, client device 103 retrieves the next service from the sorted list (step 601) and the process from step 601 onwards is repeated.

If the service currently being processed is the last service in the sorted list of services from step 305, client device 103 follows the FIG. 7 process (step 609).

The process followed once client device 103 has either scheduled to record the event retrieved in step 401 or made a determination that the event retrieved in step 401 cannot be recorded (e.g. because the user does not have rights to access a service on which the event is to be broadcast) will now be described in more detail in relation to FIG. 7.

Client device 103 checks whether or not the event retrieved in step 401 was the last event in the play list XML file (step 701).

If the event retrieved in step 401 was the last event in the play list XML file then the process ends.

If the event retrieved in step 401 was not the last event in the play list XML file, client device 103 retrieves the next event from the play list XML file and the process from step 401 onwards is repeated (step 703).

Referring once again to the example play list XML file described above, if this play list XML file were received by client device 103, client device 103 would first parse push_VOD_event_A. Then client device 103 would determine that push_VOD_service_4 (the service specified with push_VOD_event_A) is not in any service group and that push_VOD_service_4 is a free-to-air service. Client device 103 would therefore schedule to record push_VOD_service_A.

Client device 103 would then parse push_VOD_event_B and would determine that push_VOD_service_5 (the service specified with push_VOD_event_B) is not in any service group. Client device 103 would determine that a user would need to subscribe to at least one of the subscription offers from operator 128 specified in the access rights block of the configuration XML file in association with push_VOD_service_5 in order to be able to schedule the recording of push_VOD_event_B. Assuming the user does have the relevant subscription, client device 103 schedules to record push_VOD_event_B. Otherwise, client device 103 skips to parse the next event in the play list XML file.

In parsing push_VOD_event_C from the play list XML file, client device 103 would determine that push_VOD_service_2 (the service specified with push_VOD_event_C) is specified in service_group_1. In this case, by following the steps specified above in relation to FIG. 6, client device 103 will use the service in service_group_1 having the best video quality that is available to the user for recording push_VOD_event_C.

According to the system and method described above, in deciding which TV programs to ‘push’ to users, a broadcast operator only writes one instance of that TV program to the play list (typically the first one found in the schedule). Then later, the client device is able to determine if the same TV program is available at the same time on a different channel offering a better video quality than the TV channel on which the broadcaster specified the TV program would be broadcast. The size of the play list can therefore be reduced; broadcast operators do not need to search for all instances of a TV program in the broadcast schedule; space on the storage devices on users' client devices is not taken up by recordings that are not useful to the user; and users' client device preferences and settings can be taken into account when push VOD recordings are scheduled.

It should be noted that the choice of the best service to use for a push VOD recording based on the above described concept of service groups could be extended. For example, the channel list appearing in an electronic program guide (EPG) provided by client device could be updated and ordered according to the service groups. Also, user initiated recordings (as opposed to push VOD recordings) could be made according to the service groups so that a user would simply have to select the TV program they wanted to record and then the client device would make a determination of the most suitable service to use in the recording of the TV program.

Although the above embodiments have been described in the context of a DVB implementation, someone skilled in the art will realise that other implementations are possible. The term “service” as used in the claims that follow is intended to include the MPEG concept of a “Program”. A “service” can also be referred to as a “channel” in other contexts. An “event”, as used in the claims that follow, can also sometimes be referred to as a “program” (although this is not to be confused with the DVB concept of a program or the MPEG concept of a program.)

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof.

1. A method of operating a receiving device to schedule a recording of an event, said method comprising:
receiving service group data defining a service group, said service group comprising a plurality of services each being associated with a different video quality, each service in said plurality of services transmitting events, wherein events on one service in said service group are the same as and transmitted at a same time as other events on a different service in said service group;
receiving event data defining an event to be recorded, said event data specifying a service transmitting said event; and
if said service transmitting said event is a member of said service group, scheduling a recording of said event using a service in said service group associated with a highest available video quality accessible by said receiving device.

2. A method according to claim 1, wherein said highest available video quality accessible by said receiving device is dependent upon use of a suitable connection used to connect said receiving device to a display.

3. A method according to claim 1, wherein said service group data is received in a configuration file comprising: said service group data and access rights data defining access rights required by said receiving device to access each service in said plurality of services.

4. A method according to claim 1, wherein said event data is received from a headend.

5. A method according to claim 4, wherein said event data is received in an event playlist defining a plurality of events to be recorded by said receiving device.

6. A method according to claim 1, wherein said event data is received from a user of said receiving device.

7. A receiving device for scheduling a recording of an event, said receiving device comprising:
means for receiving service group data defining a service group, said service group comprising a plurality of services each being associated with a different video quality, each service in said plurality of services transmitting events, wherein events on one service in said service group are the same as and transmitted at a same time as other events on a different service in said service group;
means for receiving event data defining an event to be recorded, said event data specifying a service transmitting said event; and
means for scheduling a recording of said event using a service in said service group associated with a highest available video quality if said service transmitting said event is a member of said service group.

8. A receiving device operable to schedule a recording of an event, said receiving device comprising:
a receiver operable to receive service group data defining a service group, said service group comprising a plurality of services each being associated with a different video quality, each service in said plurality of services transmitting events, wherein events on one service in said service group are the same as and transmitted at a same time as other events on a different service in said service group;
a receiver operable to receive event data defining an event to be recorded, said event data specifying a service transmitting said event; and
a scheduler operable to schedule a recording of said event using a service in said service group associated with a highest available video quality if said service transmitting said event is a member of said service group.
